(19) United States
(12) Patent Application Publication
(10) Pub. No.: US 2004/0212601 A1
(43) Pub. Date: Oct. 28, 2004

(54) Method and apparatus for improving accuracy of touch screen input devices

(76) Inventors: Anthony Cake, Meyrin (CH); Yann Oeffner, Founex (CH)

Correspondence Address: FROMMER LAWRENCE & HAUG, 745 FIFTH AVENUE- 10TH FL., NEW YORK, NY, 10151, US

(21) Appl. No.: 10/830,788

(22) Filed: Apr. 23, 2004

Related U.S. Application Data
(60) Provisional application No. 60/465,039, filed on Apr. 24, 2003.

(51) Int. Cl. G09G 5/00

(52) U.S. Cl. 345/173

(57) ABSTRACT

An information receiving method and apparatus, comprising a touch screen and a processor for providing a graphical user interface on the touch screen, and for receiving and interpreting touch screen data from the touch screen, the graphical user interface presenting one or more predefined selection buttons on the touch screen. A CPU for receiving touch screen information from the processor is also provided. A predefined area of the touch screen corresponding to each of said one or more selection buttons provided by said graphical user interface includes an area of the touch screen different from the displayed selection buttons on the graphical user interface.

### CROSS REFERENCE TO RELATED APPLICATIONS

This application claims the benefit of U.S. Provisional application Serial No. 60/465,039 filed Apr. 24, 2003, the entire contents of which are incorporated herein by reference.

### BACKGROUND OF THE INVENTION

The use of touch screens as an entry mechanism on various computer control devices has become far more prevalent in recent times. Traditionally, a mouse was used to manipulate a pointer in a screen to make a particular selection from a plurality of graphical selections. However, the use of such a mouse had a number of problems.

First, the mouse required desk space to be available for the movement thereof, thus reducing the amount of space available for other material. This becomes even more critical if the mouse is being used in conjunction with test equipment or other equipment in a non-traditional computing environment. Furthermore, the use of a mouse is an indirect selection method, and may result in incorrect selections by a user.

Thus, while the use of a touch screen cures the defects noted above, as the inventors of the present invention have determined, additional problems may result from the use of touch screens.

### SUMMARY OF THE INVENTION

The inventors of the present invention have determined that the use of a touch screen generates additional problems in that typically a user's finger is larger than a point designated by a mouse. Furthermore, touch screens on various apparatuses may be included particularly because the apparatus is smaller than a standard computer, and therefore has a smaller screen. This is also likely to translate into smaller buttons being presented on the touch screen to the user. Therefore, in order to ensure the ability of a graphical user interface to properly interpret a user's touch, selection buttons on the screen must be increased in size, and additionally space between these selection buttons must be increased. However, such modifications have the obvious drawbacks of using up substantial real estate on the computer or instrument display screen, and therefore are undesirable.

In accordance with the invention, an improved method and apparatus for interpreting and improving the accuracy of touch screen input is disclosed. In accordance with the invention, standard, traditionally sized touch screen selection buttons are utilized, and a predefined area about each of the selected buttons is defined as being associated with the corresponding selection button. Thus, if a user touches within the predefined area about the selection button, even if it is outside the graphic location of the selection button, the selection button will register as being properly selected, and the size of the selection button has been effectively increased. Any particular shape of this additional predefined area may be employed in order to increase the overall effective size of the selection button. Furthermore, it is not necessary to increase the overall effective size of all of the touch screen buttons by the same amount. Rather, in accordance with the invention, the effective size of buttons that are more likely to be selected may be increased more than others so that real estate on the display is more appropriately utilized. Alternatively, the effective size of particular buttons may be increased while the effective size of other buttons may be maintained and even reduced in accordance with their importance. Thus, it would be undesirable to increase the effective size of a system reset button so substantially that a user might press it by mistake. However, for example, when used with test equipment, the effective size of a “Start Trigger” or “Start Acquisition” button might be increased substantially so that a user may more easily begin acquisition of a signal. Along similar lines, in accordance with the invention, the effective size of particular selection buttons may be increased based upon data acquired, or particular types of data being acquired, and therefore the various effective sizes of the various selection buttons provided being content specific. In this manner, the available real estate on display may be most appropriately used, and ensure that a user properly makes selections from the touch screen as intended. Additionally, the effective size of one or more of the buttons could be increased if it is determined that a particular user employs that button quite often. Thus, rather than simply increasing the effective size of a traditionally often used button, the effective size of an actually often used button can be increased.

Furthermore, in addition to providing larger and variable sized effective selection buttons, in accordance with the invention, if an input selection by a user on the touch screen fails to make contact with any effective portion of a selection button, a mathematical determination may be made as to the most likely input intended by the user, or alternatively, two or more of the most likely inputs intended by a user. Thereafter, rather than simply indicating this as the selection, the user may be prompted to confirm that a particular selection had been made, or to choose from between two or more selections. In this manner, even if the graphical user interface is unable to determine precisely which input was intended, the user is notified of the error, and is asked to reselect based upon a reduced set of choices. Additionally, if it is determined that the user is missing all of the buttons in a similar direction over a predetermined period of time, a determination may also be made that the calibration of the touch screen is off. The invention can then move the effective areas of the buttons to correspond to the actual portions pressed by a user, or the apparatus can automatically begin a new touch screen calibration process.

It is therefore an object of the invention to provide an improved method and apparatus for improving the accuracy of touch screen input devices that improve over the prior art.

Still other objects and advantages of the invention will in part be obvious and will in part be apparent from the specification and the drawings.

The invention accordingly comprises the several steps and the relation of one or more of such steps with respect to each of the others, and the apparatus embodying features of construction, combinations of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawings, in which:

FIG. 1 depicts a computerized system for receiving a touch screen input;

FIG. 2 depicts a conventional system for registering touch screen input;

FIG. 3 depicts the registration of touch screen input in accordance with a first embodiment of the invention;

FIG. 4 depicts a first screen for increasing the entry size of a selection button in accordance with the invention; and

FIG. 5 depicts a second embodiment for increasing the size of the input selection in accordance with the invention.

### DETAILED DESCRIPTION OF THE PREFERRED EMBODIMENTS

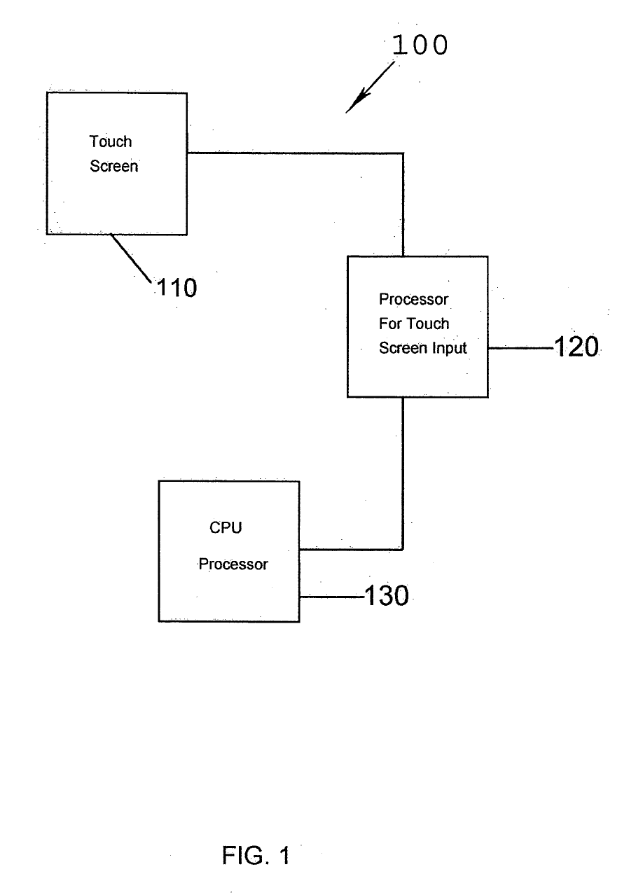

As is shown in FIG. 1, a system for receiving and interpreting touch screen input is shown generally at 100. System 100 includes a touch screen 110, a processor 120 for processing data received from touch screen 110, and a standardized CPU processor 130 for receiving the processed touch screen input and performing various functions associated with the type of equipment to which the touch screen is attached in accordance with the interpreted data. During use, a graphical user interface displays one or more selection buttons on touch screen 110. A user then touches touch screen 110 in appropriate locations in order to generate touch screen data corresponding to one or more of the displayed selection buttons. Touch screen 110 registers the precise location on the touch screen that has been touched by a user, and this information is forwarded to processor 120. Processor 120 processes this location data, and associates the location data with the location of the one or more displayed graphical selection buttons, thereby confirming that a user has made a particular selection. Thereafter, this processed selection information is passed to CPU processor 130 and utilized in accordance with various programs running for the test equipment, computer system or other apparatus which is receiving information via the touch screen system.

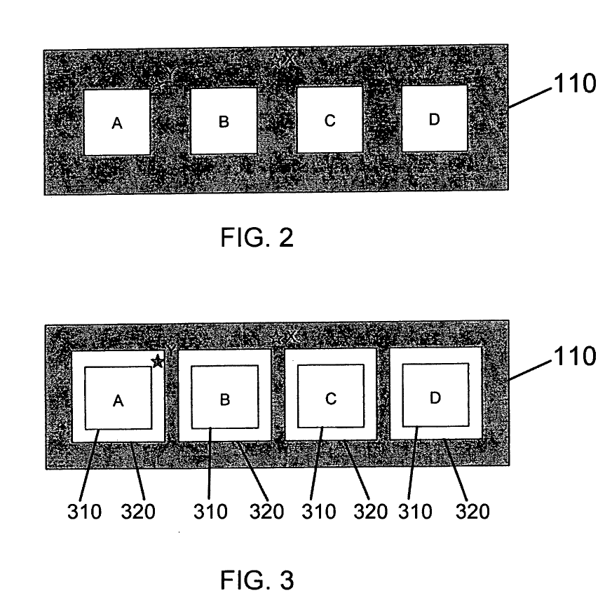

FIG. 2 depicts a conventional system for receiving touch screen information at touch screen 110. As is shown in FIG. 2, a number of graphical user interface hot spots, or selection buttons, A, B, C, D are shown at predefined locations of touch screen 110. As is shown in FIG. 2, unless a user specifically touches within one of the designated graphical displays of the selection buttons, an entry and selection will not be registered. If a user touches a touch screen at point Y and the selection is not registered, it may be beneficial to consider that because of the close proximity of point Y to selection button A, that a user actually intended to select selection button A and simply missed the spot. However, a selection made at point X causes more difficulty, and may not allow for an easy determination of the intended selection. Responses for each of these situations will now be discussed.

Referring next to FIG. 3, a method and apparatus for improving the receipt of touch screen information in accordance with a first embodiment of the invention is shown. Each selection button A, B, C, D is still graphically shown with a boundary similar to that shown in FIG. 2, now depicted at 310 for each button. However, a somewhat larger area 320 will be considered to be part of the selection button, thus effectively increasing the size of each selection button, even though not displayed as such. Thus, if a user touches either within box 310, or within increased area 320, as shown by point Y, the user will be considered to have selected selection button A. In this manner, while the display screen remains user friendly and uncluttered, an effectively larger, more usable button may be provided for a user so that touch screen selections are more accurately registered.

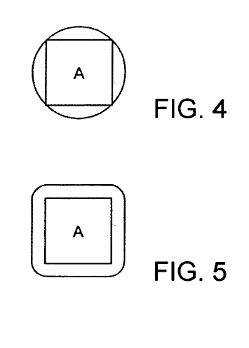

While in FIG. 3, the size of the touch screen area has been enlarged by providing a larger effective area the same shape as the original selection button, as shown in FIGS. 4 and 5, various shapes may be provided to increase the overall effective size of a touch screen registration area corresponding to a selection button. These shapes may be defined based upon proximity to other selection buttons, the importance of the particular selection button, or any other basis. Thus, in FIG. 4, a fixed radius around the center of the selection button is provided, while in FIG. 5 the effectively increased area is defined as fixed distance from the border of the selection button is similarly provided.

In addition, FIG. 3 shows that the size of each of the selection buttons has effectively been increased by the same amount. However, this is not necessarily required. Thus, as is shown in FIG. 3, selection button “A” might be a button that is more likely to be used by a user, while selection button “D” might be a system reset button. In this situation, it would be desirable to increase the effective size of selection button “A” a much larger amount, and perhaps not increase the size of selection button “D” at all (or even reduce the effective size of selection button “D” to be smaller than the displayed selection button), so that the likelihood of the touching selection button A is increased, while the likelihood of mistakenly touching selection button “D” would be decreased. Furthermore, it may even be desirable to require more than one touch of selection button D to further defend against selection thereof and inadvertent reset of a system. Thus, as a further example, when utilized in a particular type of test equipment, such as an oscilloscope, a selection button “A” may represent a trigger start, and may be provided having a relatively larger effective area while selection button “D” may correspond to the dumping of information from a memory buffer, a situation that might only be required under startup circumstances, and therefore less desirable to select.

Furthermore, in addition to setting the effective sizes of the selection buttons in general, it would also be possible to dynamically alter the effective sizes of the selection buttons based upon current data being acquired, or various functions or menu selections previously made by the user. Thus, in an oscilloscope, for example, if a user has selected a particular trace, the effective size of those selection buttons corresponding to functions that are most likely to be desirable to apply to the selected trace may be increased, while the effective size of the other selection buttons might be decreased.

Additionally, the effective size of one or more of the buttons could be increased if it is determined that a particular user employs that button quite often. Thus, rather than simply increasing the effective size of a traditionally often used button, the effective size of an actually often used button can be increased. This information may be gleaned from the various inputs associated with a user. In an apparatus that requires a user to log onto the apparatus before use, the various button selections by the user may be calculated and stored associated with the user. The effective sizes of the selection buttons can be adjusted accordingly, and these changes to the effective area can be stored with the user profile. Thus, each time the user logs onto the system, the apparatus can employ the corresponding effective selection buttons.

If a system does not require log in by users, this method can still be employed. During use, if a button is selected quite often, the apparatus can change the effective size of the selection button. The apparatus can also trace the usage of the various buttons to infer that the same user is still using the apparatus. If a predetermined period of time lapses between input (either through the touch screen, or acquisition of a signal by a user) the apparatus can reset the effective sizes of the selection buttons back to a generic standard. Additionally, even if there is no lapse in input, if the apparatus suddenly detects a change in the buttons used quite often, an assumption can be made that the user has changed, or the processes being used by the same user have changed. In either scenario, the effective areas of the selection buttons may be returned to a default size, and the process for customizing the sizes may begin again.

Additionally, if it is determined that a user is missing all of the buttons in a similar direction over a predetermined period of time, a determination may also be made that the calibration of the touch screen is off. This may be because of a previously incorrect calibration, the positioning of the touch screen (i.e. if a screen is placed above a user, the screen will always be viewed from below), or for any other reason. The invention can then move the effective areas of the buttons to correspond to the actual portions pressed by a user, or the apparatus can automatically begin a new touch screen calibration process. In either event, the systematic error is corrected.

In these manners, it is possible to dynamically adjust the ability to receive touch screen input data.

Referring back to FIG. 3, if a user selects point X, even in the FIG. 3 scenario where the effective size of the selection buttons have been increased, point X will not be included in the selection of any of the selection buttons. Thus, rather than simply attempting to determine which button a user may have intended, indicating a failed selection, or doing nothing, in accordance with the invention, an indication may be provided at both selection buttons “B” and “C”, asking a user to confirm which of the two buttons was intended. Thus, in accordance with the invention, a blinking color or other indicator might be provided at selection buttons “B” and “C” to show the user that a selection that was intended had not been properly registered, and that the user should once again select between the two most likely choices. Of course, if the touch screen was inadvertently touched, and a user does not enter a selection after a predetermined period of time, the screen returns to normal and the selection information is discarded.

One exemplary implementation of the invention is to rely on a hierarchical list of windows that are defined and retained by a modern graphical user interface. For each window, in the interface, including application name windows and individual controls, the operating system already stores the window's bounding rectangle window Z-order (whether a particular window is in front of or behind other windows), and various style information including whether the window is visible or not, for example. Thus, such features can be used to define an effective area larger (different) than the displayed selection button, thus implementing the invention.

Therefore, in accordance with the invention, various methods and apparatuses have been described for improving the ability to receive and interpret touch screen data. By using the features of the invention, a selection on a touch screen device by a user can be most efficiently used, and touch screen input data received most accurately.

It will thus be seen that the objects set forth above, among those made apparent from the preceding description, are efficiently attained and, because certain changes may be made in carrying out the above method and in the constructions set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. An information receiving apparatus, comprising:
a touch screen;
a processor for providing a graphical user interface on said touch screen, and for receiving and interpreting touch screen data from the touch screen, said graphical user interface presenting one or more predefined selection buttons on the touch screen; and
a CPU for receiving touch screen information from the processor;
wherein a predefined area of said touch screen corresponding to each of said one or more selection buttons provided by said graphical user interface includes an area of the touch screen different from the displayed selection buttons on the graphical user interface.

2. The apparatus of claim 1, wherein when a user touches the touch screen in the predefined area corresponding to one of the one or more selection buttons, but outside the displayed selection button, the processor interprets the corresponding selection button as having been selected.

3. The apparatus of claim 2, wherein the predefined area is selected in accordance with an importance of the corresponding selection button.

4. The apparatus of claim 2, wherein the predefined area is selected in accordance with a likelihood of selection of the corresponding selection button.

5. The apparatus of claim 4, wherein the likelihood of selection of the corresponding selection button is determined based upon a historical memory of selections made by a user.

6. The apparatus of claim 2, wherein the predefined area is defined as an area adjacent to and surrounding the corresponding selection button.

7. The apparatus of claim 1, wherein, upon selection of a portion of the touch screen comprising neither a selection button nor a predefined area, a calculation is made to determine one or more most likely intended selection buttons.

8. The apparatus of claim 7, wherein the one or more most likely intended selection buttons are designated, and a user is requested to select from the one or more designated selection buttons.

9. An information receiving method, comprising the steps of:
providing a graphical user interface on a touch screen;
presenting one or more predefined selection buttons on the touch screen in accordance with said graphical user interface;
receiving and interpreting touch screen data from the touch screen; and
receiving touch screen information from the processor;
wherein a predefined area of said touch screen corresponding to each of said one or more selection buttons provided by said graphical user interface includes an area of the touch screen different from the displayed selection buttons on the graphical user interface.

10. The method of claim 9, wherein when a user touches the touch screen in the predefined area corresponding to one of the one or more selection buttons, but outside the displayed selection button, the processor interprets the corresponding selection button as having been selected.

11. The method of claim 10, further comprising the step of selecting the predefined area in accordance with an importance of the corresponding selection button.

12. The method of claim 10, further comprising the step of selecting the predefined area in accordance with a likelihood of selection of the corresponding selection button.

13. The method of claim 12, wherein the likelihood of selection of the corresponding selection button is determined based upon a historical memory of selections made by a user.

14. The method of claim 10, further comprising the step of defining the predefined area as an area adjacent to and surrounding the corresponding selection button.

15. The method of claim 9, wherein, upon selection of a portion of the touch screen comprising neither a selection button nor a predefined area, a calculation is made to determine one or more most likely intended selection buttons.

16. The method of claim 15, further comprising the steps of:
designating one or more most likely intended selection buttons; and
selecting a desired selection button from the one or more designated selection buttons.

17. A touch screen information gathering system for use with test equipment, comprising:
a touch screen;
a processor for providing a graphical user interface on said touch screen, and for receiving and interpreting touch screen data from the touch screen, said graphical user interface presenting one or more predefined selection buttons on the touch screen, the one or more predefined selection buttons being defined in accordance with a data being tested by the test equipment; and
a CPU for receiving touch screen information from the processor;
wherein a predefined area of said touch screen corresponding to each of said one or more selection buttons provided by said graphical user interface includes an area of the touch screen different from the displayed selection buttons on the graphical user interface.

18. The system of claim 17, wherein a historical memory of selections of a user is retained along with a user information file corresponding to the user.

19. The system of claim 18, wherein a likelihood of selection of a selection button is determined based upon a historical memory of selections made by a user; and
wherein an effective area of one or more of the selection buttons is determined based upon the historical memory of selections made by the user.

20. The system of claim 18, wherein when said historical memory of selection made by a user indicate that a user is improperly selecting a number of selection buttons in a similar direction, by a similar amount, the touch screen is recalibrated.
